(19) United States
(12) Patent Application Publication
(10) Pub. No.: US 2005/0069644 A1
(43) Pub. Date: Mar. 31, 2005

(54) Micro-stamping method for photoelectric process

(75) Inventors: Kuo-Huang Hsieh, Taipei (TW); Long-Sun Huang, Taipei (TW); Sen-Yeu Yang, Taipei (TW); Da-Ming Wang, Yangmei Township (TW); Pe-Zen Chang, Taipei (TW); Chih-Yuan Chang, Luodong Township (TW); Wei-Yen Chen, Shalu Township (TW)

Correspondence Address: RUBEN C. DELEON, 100 CRESCENT COURT, SUITE 700, DALLAS, TX, 75201, US

(73) Assignee: National Taiwan University, Taipei (TW)

(21) Appl. No.: 10/674,153

(22) Filed: Sep. 29, 2003

(51) Int. Cl. B05D 1/36; B05D 5/00

(52) U.S. Cl. 427/258; 427/429; 427/162

(57) ABSTRACT

This invention discloses a micro-stamping method for photoelectric process. First of all, in this invention, the micro-stamping method provides a stamp, an ink, an inkpad and a substrate, wherein the stamp or the inkpad having a specific raised pattern and the ink is one element of the group consisting of red ink, green ink and blue ink. Further, by adherence of the ink to the stamp, the specific pattern can be transferred to the surface of the substrate. Furthermore, this micro-stamping method comprises an ink adherence process, a positioning process, a pattern transferring process and a fixation process, and the above-mentioned processes will repeat until the three inks, such as red ink, green ink and blue ink, all adhered and fixed on the predetermined places of substrate. Moreover, this invention can be applied in the fabricating of color filters of TFT-LCD, emitting layers of OLED (Organic Light Emitting Diode), emitting layers of PLED (Polymer Light Emitting Diode) or other related photoelectric processes.

### BACKGROUND OF THE INVENTION

1. Field of the Invention

This present invention relates to a micro-stamping method, and more particularly, to a micro-stamping method for photoelectric process.

2. Description of the Prior Art
Color filters formation typically involves depositing three primary color dot (red, green and blue) patterns within the specific region on a suitable substrate, such as glass. Furthermore, there are various methods applied for fabricating color filters, such as dyeing method, pigment dispersed method, electro-deposition method and ink-jet printing method, and detail descriptions are as follows:

The dyeing method is developed in early years, and this method providing a resin as an adsorbing layer, wherein the resin is photosensitive, water-soluble and adhesive. First, the resin is coated on the glass substrate, and then the specific pattern is formed by photolithography. Next, the substrate with the patterned adsorbing layer is immerged into solution containing inks to adsorb inks. Afterwards, the ink adsorbed on the adsorbing layer is solidified by a baking process. Above-mentioned processes are repeated until red, green and blue inks are all solidified on the substrate. According to the complicated steps, high costs and unreliable quality of products, this dyeing method is gradually disappearing.

The pigment dispersed method is the most popular fabricating method in the industry, and this method providing a photoresist as a dispersion ink, wherein the photoresist comprises colored inks, photosensitive materials, acrylate resin and solvents, so the photoresist is photoreactive and thermosetting. First, the substrate is cleaned, and black matrix is then formed on the substrate. The photoresist is spin-coated on the glass substrate, and then the specific pattern is formed by photolithography. Above-mentioned processes are repeated until red, green and blue inks are all solidified on the substrate. According to the complicated steps, high costs and high waste of photoresist, this pigment dispersed method can not meet the requirement for high throughput and cost down in the future.

The main step of the electro-deposition method is forming a transparent electrode layer on the substrate, and then the specific pattern is formed by photolithography. Next, the substrate with the transparent electrode layer is immerged into solution containing inks, resins and electrolytes to be plated with specific colored ink. Afterwards, the plated-ink on the transparent electrode layer is solidified by a baking process. Above-mentioned processes are repeated until red, green and blue inks are all solidified on the substrate. According to the complicated electrochemical reactions, various controlling parameters and reducing of transparency, it is hard for this electro-deposition method to fabricate photoelectric element with larger and more complicated patterns.

In the inkjet printing method, first of all, the glass substrate is surface modified, which means an ink adsorbing layer is formed on the substrate, to make sure that the ink can be adsorbed stably. Next, the red, green and blue inks are located on the ink adsorbing layer by inkjet printing, and then the specific patterns are formed. Although this method is pretty simple and can reduce the waste of colored inks by photolithography, the yield is not good enough. Because if the position process for the inkjet head is not precise, the different inks would mix with one another and cause defects. According to the need for expansive apparatuses and limits for larger scale color filter's production, this pigment dispersed method still haves many problems to be dissolved.

On the other hand, organic electro luminescence has attracted tremendous attention due to its advantages over other display panels, and has the greatest potential to become the dominant flat panel display in the next generation. These advantages include a larger visual angle, shorter response time, a smaller dimension in thickness, lower power consumption, simpler fabrication, no need for backlighting, and the ability for light emitting in a full color range. An organic luminescence device generally comprises a pair of electrodes (comprising an anode and cathode) and a film comprising a fluorescent organic compound. Into the organic compound layer (film), holes and electrons are injected from the anode and the cathode, respectively, thus forming excitons of the fluorescent organic compound. When the excitons are returned to ground state, the organic luminescence device emits light or causes luminescence. The organic electro luminescence could de divided into two classes by materials: one is organic light-emitting diode and the other is polymer light-emitting diode.

The materials of organic light-emitting diode usually comprise molecules with low molecular weight in solid state, and the emitting layer is fabricated by vacuum deposition method between two electrodes. Although the vacuum deposition method is a well-known skill, the vacuum equipment costs a lot. Moreover, the vacuum deposition method should be kept in high temperature, but that would damages molecules with low molecular weight. Therefore, the organic light-emitting diode usually applied in small display apparatus presently.

Most materials of polymer light-emitting diode are polymers of liquid or gel form, and the emitting layer is fabricated by spin-coating and inkjet print method between two electrodes. Although the spin-coating method is a simple skill, cheap and suitable for large area coating, the raw materials waste a lot, hard to coat thickness uniformly and not suitable for producing colorful display apparatus. On the other hand, the inkjet printing method has advantages on reducing waste of colored inks and fabricating colorful displays, but it need precision positioning system and inkjet head. According to the need for expansive apparatuses and limits for larger scale color filter's production, this inkjet printing method still have many problems to be dissolved.

According to above-mentioned descriptions, a new process is still required to meet the requirement for high throughput and cost down. Furthermore, the new process should also be applied to next generation process for fabricating photoelectric element with larger and more complicated patterns.

### SUMMARY OF THE INVENTION

In accordance with the present invention, a micro-stamping method for photoelectric process is provided. The micro-stamping method can meet the requirement for high throughput and cost down. Furthermore, this invention could also be applied to next generation process for fabricating photoelectric element with larger and more complicated patterns.

It is one of the objects of this invention to utilize the stamp or the inkpad having a specific raised pattern and positioning apparatus, the present invention can position and ink the substrate precisely, then the specific patterns are formed on the substrate. Comparing to conventional skills, this invention simplifies the complicated process and eliminating the lithographic process, and then reducing the cost. Therefore, the present invention does have economic advantages and can be applied in industries.

Another object of this invention is to provide a stamp with a plurality of spacers to avoid inking area outside the raised pattern on the stamp, and also avoid inking area outside the specific region of the substrate. Moreover, this invention provides a stamp with a plurality of spacers to avoid inking area outside the specific region of the stamp, and also avoid inking area outside the specific region of the substrate.

According to above-mentioned objects, this invention discloses a micro-stamping method for photoelectric process. First of all, in this invention, the micro-stamping method provides a stamp, an ink, an inkpad and a substrate, wherein the stamp or the inkpad having a specific raised pattern and the ink is one element of the group consisting of red ink, green ink and blue ink. Further, by adherence of the ink to the stamp, the specific pattern can be transferred to the surface of the substrate. Furthermore, this micro-stamping method comprises an ink adherence process, a positioning process, a pattern transferring process and a fixation process, and the above-mentioned processes will repeat until the three inks, such as red ink, green ink and blue ink, all adhered and fixed on the predetermined places of substrate. Moreover, this invention can be applied in the fabricating of color filters of TFT-LCD, emitting layers of OLED (Organic Light Emitting Diode), emitting layers of PLED (Polymer Light Emitting Diode) or other related photoelectric processes.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1A shows a flowchart of micro-stamping method for photoelectric process with a stamp having a raised pattern, wherein the method is provided in the first preferred embodiment of this invention;

FIG. 1B shows a flowchart of micro-stamping method for photoelectric process with a plate stamp having a raised pattern, wherein the method is provided in the first preferred embodiment of this invention;

FIG. 1C shows a flowchart of micro-stamping method for photoelectric process with a roller stamp having a raised pattern, wherein the method is provided in the first preferred embodiment of this invention;

FIG. 1D shows a flowchart of micro-stamping method for photoelectric process with a plate stamp having a raised pattern and a plurality of spacers, wherein the spacers are height-adjustable or the substrate further comprises a plurality of dents, and the this method is provided in first preferred embodiment of this invention;

FIG. 1E shows a flowchart of micro-stamping method for photoelectric process with a plate stamp comprising a flexible material, and the plate stamp can deform to ink by the support of the spacers while under pressure, and the this method is provided in first preferred embodiment of this invention;

FIG. 1F shows a flowchart of micro-stamping method for photoelectric process with the inkpad comprising an automatic ink dropping apparatus for a roller stamp having a raised pattern, wherein the method is provided in the first preferred embodiment of this invention;

FIG. 1G shows a flowchart of micro-stamping method for photoelectric process with the inkpad comprising an automatic ink feeder for a roller stamp having a raised pattern, wherein the method is provided in the first preferred embodiment of this invention;

FIG. 2A shows a flowchart of micro-stamping method for photoelectric process with an inkpad having a raised pattern, wherein the method is provided in the second preferred embodiment of this invention;

FIG. 2B shows a flowchart of micro-stamping method for photoelectric process with a plate stamp and an inkpad having a raised pattern, wherein the method is provided in the second preferred embodiment of this invention;

FIG. 2C shows a flowchart of micro-stamping method for photoelectric process with a roller stamp and an inkpad having a raised pattern, wherein the method is provided in the second preferred embodiment of this invention;

FIG. 2D is a combination of FIG. 2A with FIG. 2C and shows the complete flow chart of operating roller stamp relative to the inkpad having a raised pattern, and this figure is based on the second preferred embodiment of this invention.

FIG. 2E shows a flowchart of micro-stamping method for photoelectric process with an inkpad having a raised pattern and a plate stamp having a plurality of spacers, wherein the spacers are height-adjustable or the substrate further comprises a plurality of dents, and the this method is provided in second preferred embodiment of this invention;

FIG. 2F is a combination of FIG. 2A with FIG. 2E and shows the complete flow chart of operating plate stamp relative to the inkpad having a raised pattern, and this figure is based on the second preferred embodiment of this invention.

FIG. 2G shows a flowchart of micro-stamping method for photoelectric process with a plate stamp comprising a flexible material, and the plate stamp can deform to ink by the support of the spacers while under pressure, and the this method is provided in second preferred embodiment of this invention;

FIG. 3 shows a representative working ways among the inkpad, the substrate and the roller stamp having a raised pattern, wherein the inkpad and the substrate contact the roller stamp separately, and the moving directions of the inkpad and the substrate are parallel and in opposite direction, and this figure is according to third preferred embodiment of this invention;

FIG. 4 shows a representative working ways among the inkpad having a raised pattern, the substrate and the roller stamp, wherein the inkpad and the substrate contact the roller stamp separately, and the moving directions of the inkpad and the substrate are parallel and in opposite direction, and this figure is according to fourth preferred embodiment of this invention;

FIG. 5 shows a representative working ways among the inkpad, the substrate and the stamp apparatus having a raised pattern, wherein the inkpad and the substrate contact the roller stamp separately, and the moving directions of the inkpad and the substrate are parallel and in opposite direction, and this figure is according to fifth preferred embodiment of this invention;

FIG. 6 shows a representative working ways among the inkpad having a raised pattern, the substrate and the stamp apparatus, wherein the inkpad and the substrate contact the roller stamp separately, and the moving directions of the inkpad and the substrate are parallel and in opposite direction, and this figure is according to sixth preferred embodiment of this invention;

FIG. 7 shows a representative working ways among the inkpad, the substrate and the roller stamp having a raised pattern, wherein the inkpad and the substrate are on the same plane and contact the roller stamp separately, and the moving directions of the inkpad and the substrate are the same, and this figure is according to seventh preferred embodiment of this invention;

FIG. 8 shows a representative working ways among the inkpad having a raised pattern, the substrate and the roller stamp, wherein the inkpad and the substrate are on the same plane and contact the roller stamp separately, and the moving directions of the inkpad and the substrate are the same, and this figure is according to seventh preferred embodiment of this invention;

FIG. 9A is a representative figure of inking each ink on the substrate with a specific raised pattern according to this invention.

FIG. 9B is a representative figure of inking each ink on the substrate with a specific raised pattern according to this invention.

### DESCRIPTION OF THE PREFERRED EMBODIMENTS

What is probed into in the invention is about a composite membrane for separating organic solvents and a method for forming the same. Detailed descriptions of the production, structure and elements will be provided in the following in order to make the invention thoroughly understood. Obviously, the application of the invention is not confined to specific details familiar to those who are skilled in the composite membrane for separating organic solvents. On the other hand, the common elements and procedures that are known to everyone are not described in details to avoid unnecessary limits of the invention. Some preferred embodiments of the present invention will now be described in greater detail in the following. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

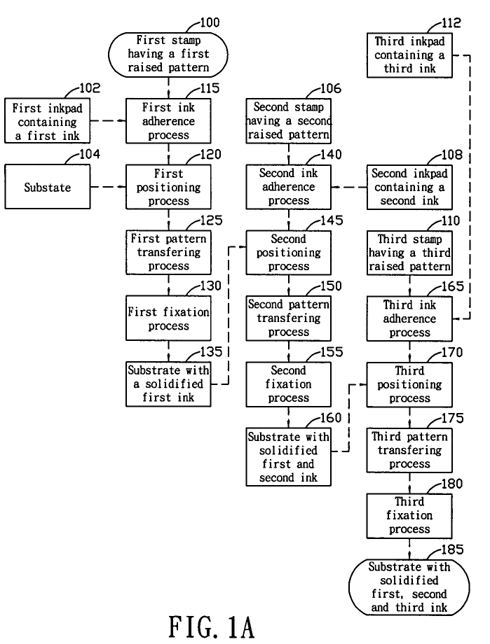

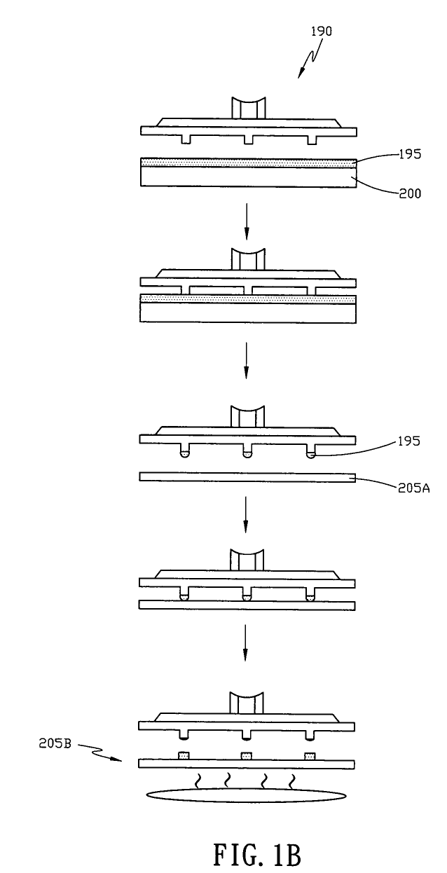

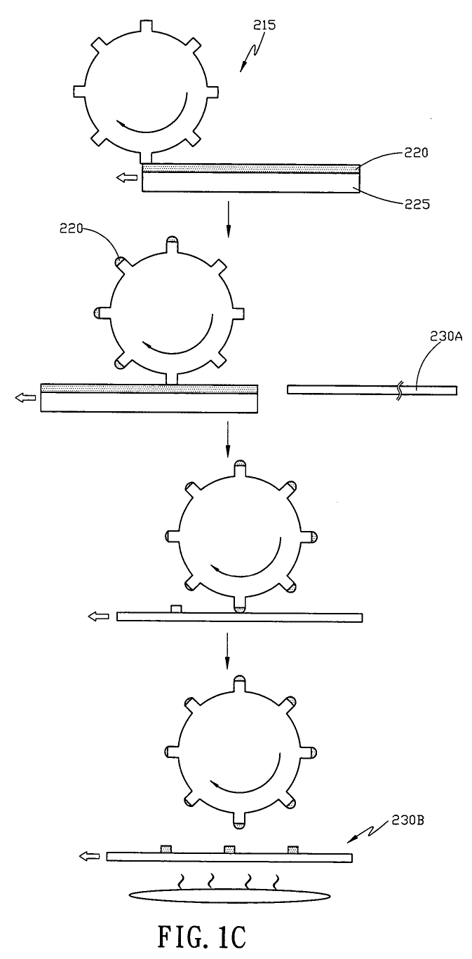

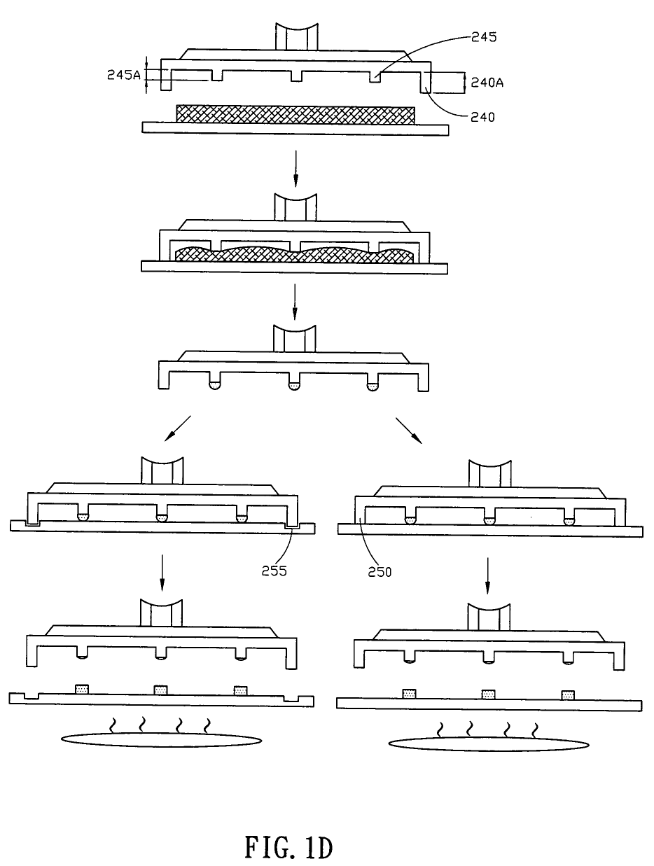

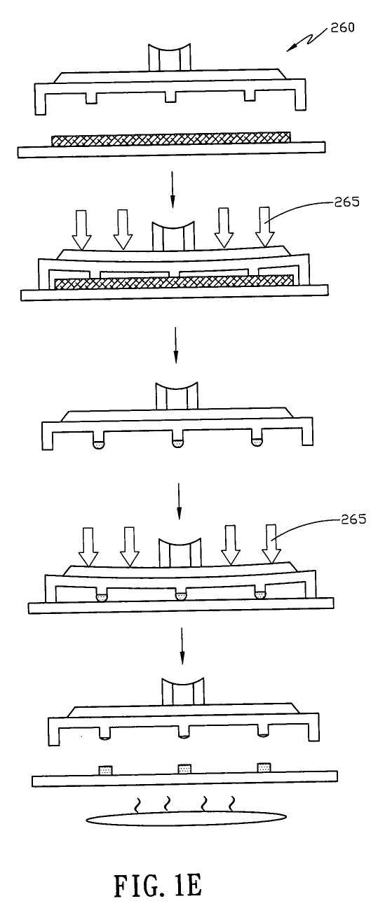

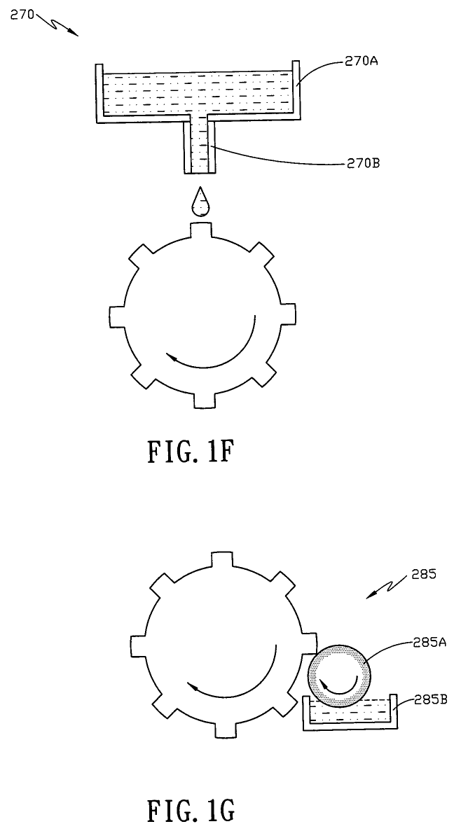

Referring to FIG. 1A, which illustrates the first preferred embodiment of this invention, a first stamp 100 having a first raised pattern, a first inkpad 102 containing a first ink and a substrate 104 are provided. Next, a first ink adherence process 115 is performed by first inkpad 102 to ink first raised pattern on the first stamp 100. Then, a first positioning process 120 is performed to move the inked first stamp 100 to a specific place precisely relative to the first predetermined region of the substrate 104. After first positioning process 120, a first pattern transferring process 125 is performed by the inked first stamp 100 to ink first predetermined region of the substrate 104, so as to transfer first raised pattern on the surface of the substrate 104. Then, a first fixation process 130 is performed to solidify the first ink on the surface of the substrate 104, so as to form a substrate 135 with solidified first ink.

Referring to FIG. 1A, in this embodiment, a second stamp 106 having a second raised pattern and a second inkpad 108 containing a second ink are provided. Next, a second ink adherence process 140 is performed by second inkpad 108 to ink second raised pattern on the second stamp 106. Then, a second positioning process 145 is performed to move the inked second stamp 106 to a specific place precisely relative to the second predetermined region of the substrate 135 with solidified first ink. After second positioning process 145, a second pattern transferring process 150 is performed by the inked second stamp 106 to ink second predetermined region of the substrate 135 with a solidified first ink, so as to transfer second raised pattern on the surface of the substrate 135 with solidified first ink. Afterwards, a second fixation process 155 is performed to solidify the second ink on the surface of the substrate, so as to form a substrate 160 with solidified first and second ink.

Referring to FIG. 1A, in this embodiment, a third stamp 110 having a third raised pattern and a third inkpad 112 containing a third ink are provided. Next, a third ink adherence process 165 is performed by third inkpad 112 to ink third raised pattern on the third stamp 110. Then, a third positioning process 170 is performed to move the inked third stamp 110 to a specific place precisely relative to the third predetermined region of the substrate 160 with solidified first and second ink. After third positioning process 170, a third pattern transferring process 175 is performed by the inked third stamp 110 to ink third predetermined region of the substrate 160 with solidified first and second ink, so as to transfer third raised pattern on the surface of the substrate 160 with solidified first and second ink. Afterwards, a third fixation process 180 is performed to solidify the third ink on the surface of the substrate, so as to form a substrate 185 with solidified first, second and third ink.

In this embodiment, first stamp is taken for example. When first stamp is a plate stamp as shown in FIG. 1B, a first plate stamp 190 having a first raised pattern, a first inkpad 200 containing a first ink 195 and a substrate 205A are provided. Next, a first ink adherence process 115 is performed by first inkpad 200 to ink first raised pattern on the first plate stamp 190. Then, a first positioning process 120 is performed to move the inked first plate stamp 190 to a specific place precisely relative to the first predetermined region of the substrate 205A. After first positioning process 120, a first pattern transferring process 125 is performed by the inked first plate stamp 190 to ink first predetermined region of the substrate 205A, so as to transfer first raised pattern on the surface of the substrate 205A. Afterwards, a first fixation process 130 is performed to solidify the first ink 195 on the surface of the substrate 205A, so as to form a substrate 205B with solidified first ink.

In this embodiment, first stamp is again taken for example. When first stamp is a roller stamp as shown in FIG. 1C, a first roller stamp 215 having a first raised pattern, a first inkpad 225 containing a first ink 220 and a substrate 230A are provided. Next, a first ink adherence process 115 is performed by first inkpad 225 to ink first raised pattern on the first roller stamp 215. Then, a first positioning process 120 is performed to move the inked first roller stamp 215 to a specific place precisely relative to the first predetermined region of the substrate 230A. After first positioning process 120, a first pattern transferring process 125 is performed by the inked first roller stamp 215 to ink first predetermined region of the substrate 230A, so as to transfer first raised pattern on the surface of the substrate 230A. Afterwards, a first fixation process 130 is performed to solidify the first ink 200 on the surface of the substrate 230A, so as to form a substrate 230B with solidified first ink.

Besides, referring to FIG. 1D, in this embodiment, the first plate stamp further comprises a plurality of spacers 240. A plurality of spacers 240 and the first raised pattern 245 are located at the same surface of the first plate stamp, and a plurality of spacers 240 are with a first height 240A, while the first raised pattern 245 are with a second height 245A, wherein the first height 240A is larger than the second height 245A. In another case, a plurality of spacers 240 are height-adjustable spacers 250, or the substrate further comprises a plurality of dents 255 for contacting a plurality of spacers 240. Still in another case, the first plate stamp 260 further comprises a flexible material. In first ink adherence process 115, when pressure 265 is applied on the first plate stamp, the stamp deforms to be inked with the support of the spacers 240. Next, in first pattern transferring process 125, when pressure 265 is applied on the first plate stamp, the stamp deforms to ink the substrate with the support of the spacers 240, as shown in FIG. 1E.

Referring to FIG. 1F, in this embodiment, when the first, second and third stamp are roller stamps, the inkpad comprises an automatic ink dropping apparatus 270, which comprising an ink tank 270A and an ink dropper 270B, wherein the ink dropper 270B is below the ink tank, so the ink is transported from the ink tank 270A by the ink dropper 270B. In another case, the inkpad is an automatic ink feeder 285, and the automatic ink feeder 285 comprises an ink tank 285A and a foam roller 285B, wherein the foam roller 285b is rotated and partially contacted with the ink, so as to uniformly spread the ink on the surface of the foam roller 285B by capillarity, as shown in FIG. 1G. Furthermore, each first, second and third stamp is connected with an arm which moves freely above the inkpad and the substrate so that the stamp can contact the inkpad and substrate in turn. Alternatively, the inkpad and the substrate are connected to each other by a connect device which is further connected to an arm moving freely so that the inkpad and substrate can contact the stamp in turn.

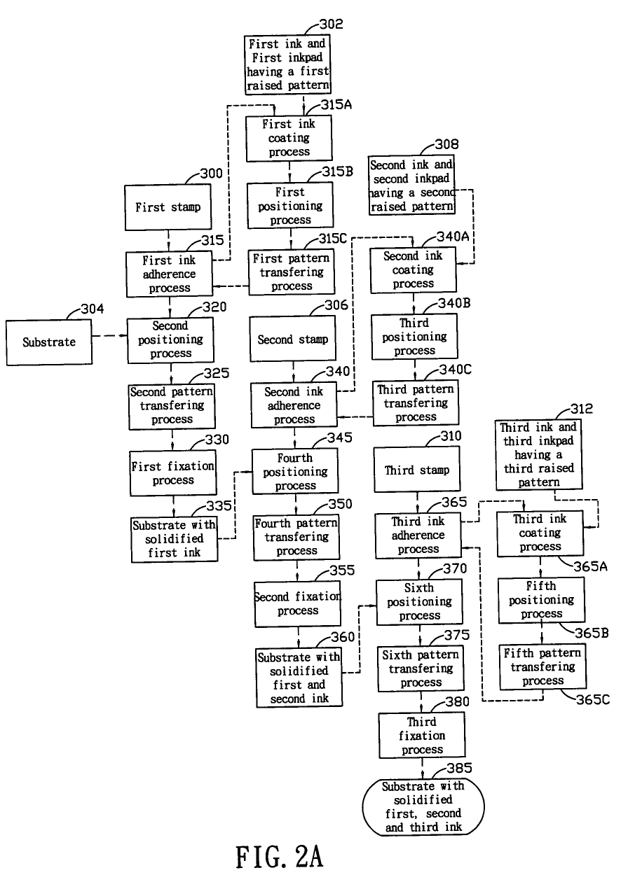

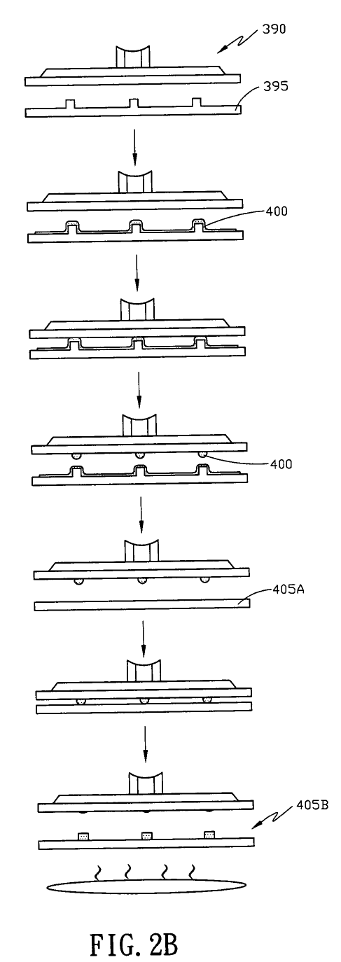

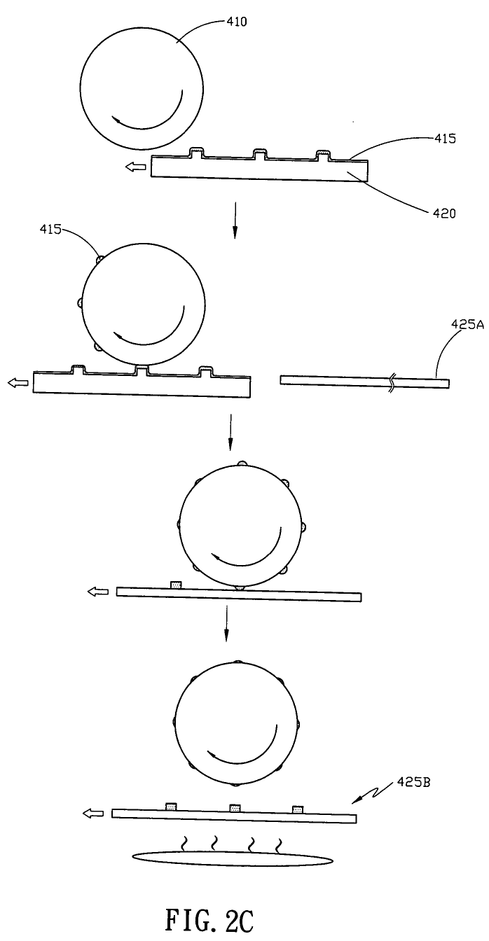

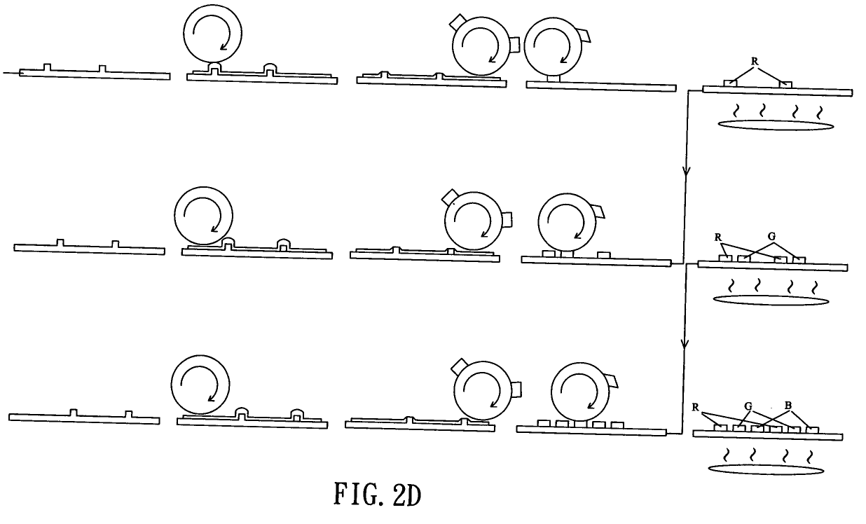

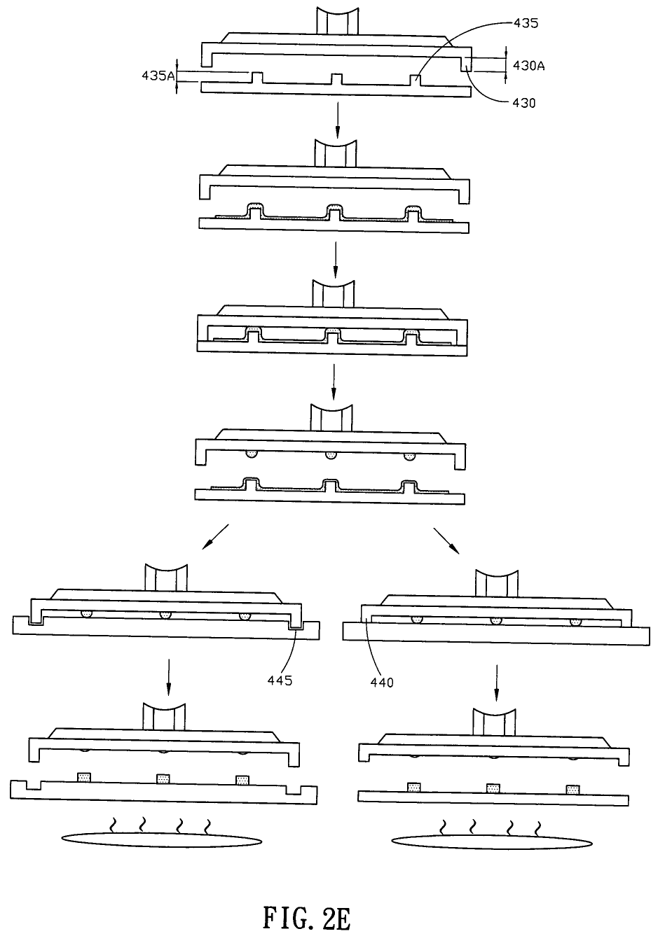

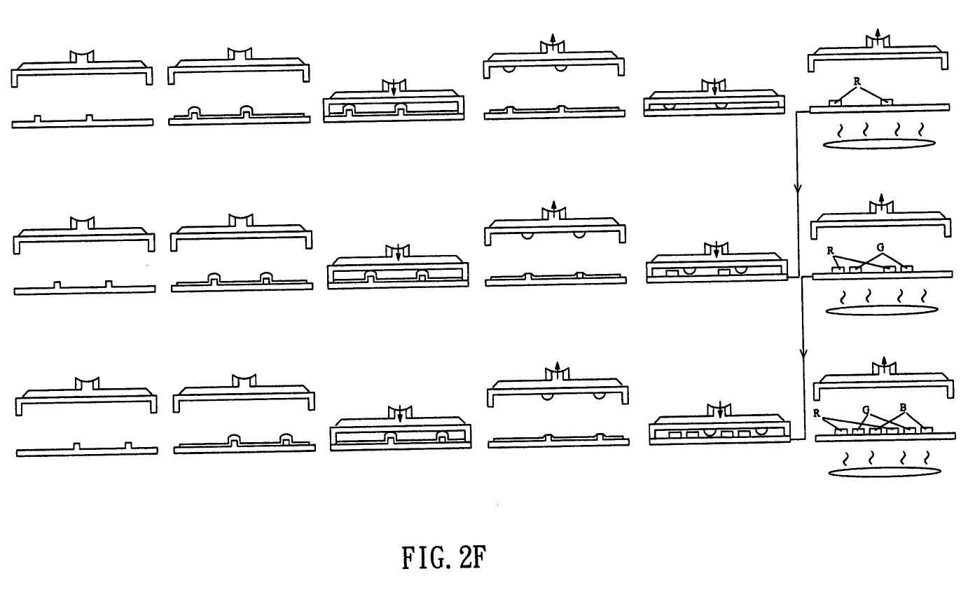

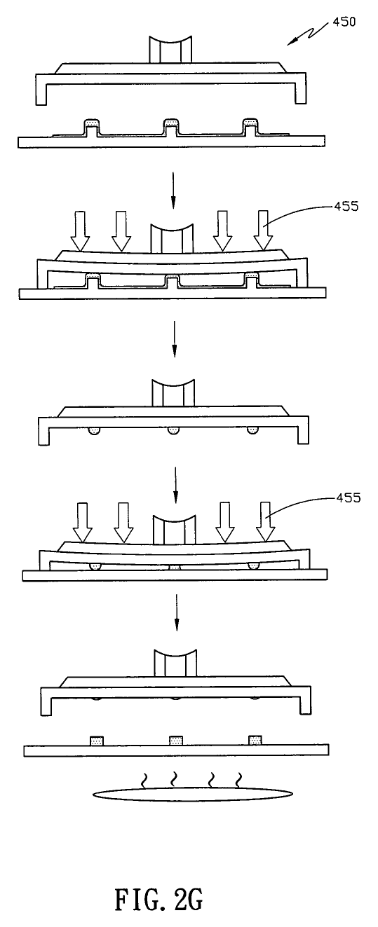

Referring to FIG. 2A, which illustrates the second preferred embodiment of this invention, a first stamp 300, a substrate 304, a first ink and a first inkpad 302 having a first raised pattern are provided. Next, a first ink adherence process 315 is performed to form a first raised pattern on the first predetermined region of the first stamp 300, wherein first ink adherence process 315 comprises a first ink coating process 315A, a first positioning process 315B and a first pattern transferring process 315C. The first ink coating process 315A is performed to coat the first ink uniformly on the first raised pattern on the first inkpad 302. Next, the first positioning process 315B is performed to move the first stamp 300 to a specific place precisely relative to the first predetermined region of the first inkpad 302. Then, the first pattern transferring process 315C is performed to ink the first predetermined region of the first stamp 300 by the first inkpad 302 and transfer the first raised pattern on the surface of the first stamp 300. After the first ink adherence process 315, a second positioning process 320 is performed to move the inked first stamp 300 to a specific place precisely relative to the first predetermined region of the substrate 304. Next, a second pattern transferring process 325 is performed to ink the first predetermined region of the substrate 304 by the first stamp 300, so as to transfer the first raised pattern on the surface of the substrate 304. Afterwards, a first fixation process 300 is performed to solidify the first ink on the surface of the substrate 304, so as to form a substrate 335 with a solidified first ink.

Referring to FIG. 2A, in this embodiment, a second stamp 306, a second ink and a second inkpad 308 having a second raised pattern are provided. Next, a second ink adherence process 340 is performed to form a second raised pattern on the second predetermined region of the second stamp 306, wherein second ink adherence process 340 comprises a second ink coating process 340A, a third positioning process 340B and a third pattern transferring process 340C. The second ink coating process 340A is performed to coat the second ink uniformly on the second raised pattern on the second inkpad 308. Next, the third positioning process 340B is performed to move the second stamp 306 to a specific place precisely relative to the second predetermined region of the second inkpad 308. Then, the third pattern transferring process 315C is performed to ink the second predetermined region of the second stamp 306 by the second inkpad 308 and transfer the second raised pattern on the surface of the second stamp 306. After the second ink adherence process 340, a fourth positioning process 345 is performed to move the inked second stamp 306 to a specific place precisely relative to the second predetermined region of the substrate 335 with a solidified first ink. Next, a fourth pattern transferring process 350 is performed to ink the second predetermined region of the substrate 335 with a solidified first ink by the second stamp 306, so as to transfer the second raised pattern on the surface of the substrate 335 with a solidified first ink. Afterwards, a second fixation process 355 is performed to solidify the second ink on the surface of the substrate, so as to form a substrate 360 with a solidified first and second ink.

Referring to FIG. 2A, in this embodiment, a third stamp 310, a third ink and a third inkpad 312 having a third raised pattern are provided. Next, a third ink adherence process 365 is performed to form a third raised pattern on the third predetermined region of the third stamp 310, wherein third ink adherence process 365 comprises a third ink coating process 365A, a fifth positioning process 365B and a fifth pattern transferring process 365C. The third ink coating process 365A is performed to coat the third ink uniformly on the third raised pattern on the third inkpad 312. Next, the fifth positioning process 365B is performed to move the third stamp 310 to a specific place precisely relative to the third predetermined region of the third inkpad 312. Then, the fifth pattern transferring process 365C is performed to ink the third predetermined region of the third stamp 310 by the third inkpad 312 and transfer the third raised pattern on the surface of the third stamp 310. After the third ink adherence process 365, a sixth positioning process 370 is performed to move the inked third stamp 310 to a specific place precisely relative to the third predetermined region of the substrate 360 with a solidified first and second ink. Next, a sixth pattern transferring process 375 is performed to ink the third predetermined region of the substrate 360 with a solidified first and second ink by the third stamp 310, so as to transfer the third raised pattern on the surface of the substrate 360 with a solidified first and second ink. Afterwards, a third fixation process 380 is performed to solidify the third ink on the surface of the substrate, so as to form a substrate 385 with a solidified first, second and third ink.

In this embodiment, first stamp is taken for example. When first stamp is a plate stamp as shown in FIG. 2B, a first plate stamp 390 having a first raised pattern, a first inkpad 395 containing a first ink 400 and a substrate 405A are provided. Next, a first ink adherence process 315 is performed by first inkpad 395 to ink first raised pattern on the first plate stamp 390, wherein first ink adherence process 315 comprises a first ink coating process 315A, a first positioning process 315B and a first pattern transferring process 315C. The first ink coating process 315A is performed to coat the first ink 400 uniformly on the first raised pattern on the first inkpad 395. Next, the first positioning process 315B is performed to move the first plate stamp 390 to a specific place precisely relative to the first predetermined region of the first inkpad 395. Then, the first pattern transferring process 315C is performed to ink the first predetermined region of the first plate stamp 390 by the first inkpad 395 and transfer the first raised pattern on the surface of the first plate stamp 390. After the first ink adherence process 315, a second positioning process 320 is performed to move the inked first plate stamp 390 to a specific place precisely relative to the first predetermined region of the substrate 405A. Next, a second pattern transferring process 325 is performed to ink the first predetermined region of the substrate 405A by the first stamp 390, so as to transfer the first raised pattern on the surface of the substrate 405A. Afterwards, a first fixation process 330 is performed to solidify the first ink 400 on the surface of the substrate 405A, so as to form a substrate 405B with a solidified first ink.

In this embodiment, first stamp is again taken for example. When first stamp is a roller stamp as shown in FIG. 2C, a first roller stamp 410 having a first raised pattern, a first inkpad 420 containing a first ink 415 and a substrate 425A are provided. Next, a first ink adherence process 315 is performed by first inkpad 420 to ink first raised pattern on the first roller stamp 410, wherein first ink adherence process 315 comprises a first ink coating process 315A, a first positioning process 315B and a first pattern transferring process 315C. The first ink coating process 315A is performed to coat the first ink 415 uniformly on the first raised pattern on the first inkpad 420. Next, the first positioning process 315B is performed to move the first roller stamp 410 to a specific place precisely relative to the first predetermined region of the first inkpad 420. Then, the first pattern transferring process 315C is performed to ink the first predetermined region of the first roller stamp 410 by the first inkpad 420 and transfer the first raised pattern on the surface of the first roller stamp 410. After the first ink adherence process 315, a second positioning process 320 is performed to move the inked first roller stamp 410 to a specific place precisely relative to the first predetermined region of the substrate 425A. Next, a second pattern transferring process 325 is performed to ink the first predetermined region of the substrate 425A by the first stamp 410, so as to transfer the first raised pattern on the surface of the substrate 425A. Then, a first fixation process 330 is performed to solidify the first ink 415 on the surface of the substrate 425A, so as to form a substrate 425B with a solidified first ink. Moreover, FIG. 2D is a combination of FIG. 2A with FIG. 2C and shows the complete flow chart of operating roller stamp relative to the inkpad having a raised pattern.

Besides, referring to FIG. 2E, in this embodiment, the first plate stamp and the first inkpad having a first raised pattern 435 with a second height 435A are taken for example, wherein the first plate stamp further comprises a plurality of spacers 430 with a first height 430A, wherein the first height 430A is larger than the second height 435A, and a plurality of spacers 430 are located at a specific surface of the first plate stamp, wherein the specific surface is predetermined to be inked. In another case, a plurality of spacers 430 are height-adjustable spacers 440, or the substrate further comprises a plurality of dents 445 for contacting a plurality of spacers 430. Furthermore, FIG. 2F is a combination of FIG. 2A with FIG. 2E and shows the complete flow chart of operating plate stamp relative to the inkpad having a raised pattern.

In addition, referring to FIG. 2G, in this embodiment, the first plate stamp 450 further comprises a flexible material. In first ink adherence process 315, when pressure 455 is applied on the first plate stamp, the stamp deforms to be inked with the support of the spacers 430. Next, in second pattern transferring process 325, when pressure 455 is applied on the first plate stamp, the stamp deforms to ink the substrate with the support of the spacers 430. Furthermore, each first, second and third stamp is connected with an arm which moves freely above the inkpad and the substrate so that the stamp can contact the inkpad and substrate in turn. Alternatively, the inkpad and the substrate are connected to each other by a connect device which is further connected to an arm moving freely so that the inkpad and substrate can contact the stamp in turn.

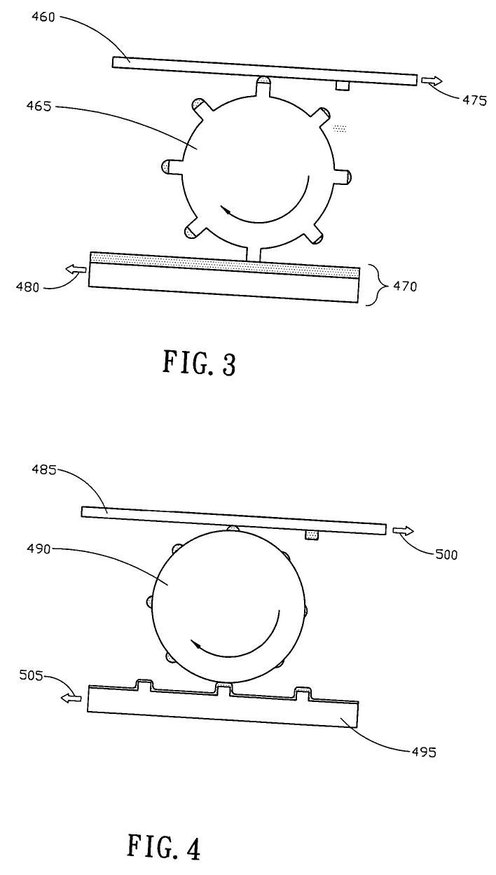

Referring to FIG. 3, which illustrates the third preferred embodiment of this invention, a roller stamp 465 having a raised pattern, an inkpad 470 containing an ink and a substrate 460 are provided, wherein the ink is one element of the group consisting of red ink, green ink and blue ink. The inkpad 470 is moved along a first tangent line 480 of the roller stamp 465 and contacted with the roller stamp 465 at a first point of tangency, while the substrate 460 is moved along a second tangent line 475 of the roller stamp 465 and contacted with the roller stamp 465 at a second point of tangency. In addition, the first tangent line 480 is parallel and in opposite direction with said second tangent line 475. Then, the inkpad 470 and the substrate 475 are moved along the first and second tangent lines 480 and 475, and the roller stamp 465 is rotated. At the first point of tangency, the raised pattern on the roller stamp 465 is inked by the inkpad 470. Next, at the second point of tangency, the predetermined region of the substrate 460 is inked by the inked roller stamp 465, so as to transfer the raised pattern on the surface of the substrate 460. Afterwards, a fixation process is performed to solidify the ink on the surface of the substrate 460 and a substrate with a solidified ink is formed. Above-mentioned processes are repeated until red, green and blue inks are all solidified on the substrate 460.

Referring to FIG. 4, which illustrates the fourth preferred embodiment of this invention, a roller stamp 490, an ink, an inkpad 495 having a raised pattern and a substrate 485 are provided, wherein the ink is one element of the group consisting of red ink, green ink and blue ink. First, the raised pattern on the inkpad 495 is inked uniformly, and the inkpad 495 is moved along a first tangent line 505 of the roller stamp 490 and contacted with the roller stamp 490 at a first point of tangency, while the substrate 485 is moved along a second tangent line 500 of the roller stamp 490 and contacted with the roller stamp 490 at a second point of tangency. In addition, the first tangent line 505 is parallel and in opposite direction with the second tangent line 500. Then, the inkpad 495 and the substrate 485 are moved along the first and second tangent lines 505 and 500, and the roller stamp 490 is rotated. At the first point of tangency, the predetermined region of the roller stamp 490 is inked by the inkpad 495, so as to transfer the raised pattern on the surface of the roller stamp 490. Next, at the second point of tangency, the predetermined region of the substrate 485 is inked by the inked roller stamp 490, so as to transfer the raised pattern on the surface of the substrate 485. Afterwards, a fixation process is performed to solidify the ink on the surface of the substrate 485 and a substrate with a solidified ink is formed. Above-mentioned processes are repeated until red, green and blue inks are all solidified on the substrate 485.

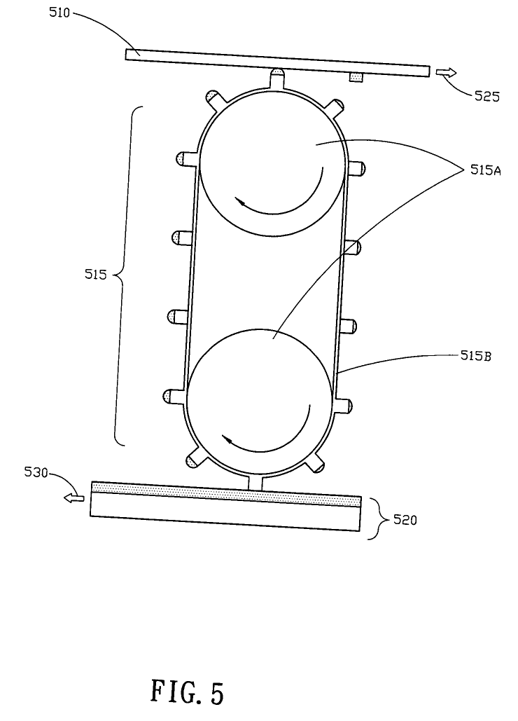

Referring to FIG. 5, which illustrates the fifth preferred embodiment of this invention, a stamp apparatus 515 having a raised pattern, an inkpad 520 containing an ink and a substrate 510 are provided, wherein the ink is one element of the group consisting of red ink, green ink and blue ink. The inkpad 520 is moved along a first direction 530 and contacted with the stamp apparatus 515 at a first point, while the substrate 510 is moved along a second direction 525 and contacted with the stamp apparatus 515 at a second point, in addition, the first direction 530 is parallel and in opposite direction with the second direction 525. Then, the inkpad 520 and the substrate 510 are moved along the first and second directions 530 and 525, and the stamp apparatus 515 is operated. At the first point, the raised pattern on the stamp apparatus 515 is inked by the inkpad 520. Next, at the second point, the predetermined region of the substrate by the inked stamp apparatus 515 is inked, so as to transfer the raised pattern on the surface of the substrate 510. Afterwards, a fixation process is performed to solidify the ink on the surface of the substrate 510, so as to form a substrate with a solidified ink. Above-mentioned processes are repeated until red, green and blue inks are all solidified on the substrate 510.

Referring to FIG. 5, in this embodiment, the stamp apparatus 515 further comprises a belt conveyer 515B having predetermined raised pattern outside thereon and a plurality of gears 515A on the inside of the belt conveyer 515B. At least two gears are contacted with the belt conveyer 515B, and a plurality of gears 515A is operated to work the stamp apparatus 515.

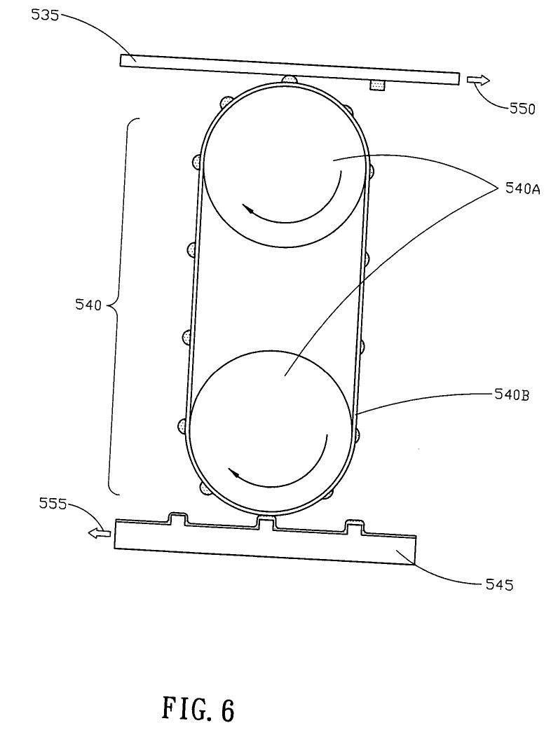

Referring to FIG. 6, which illustrates the sixth preferred embodiment of this invention, a stamp apparatus 540, an ink, an inkpad 545 having a raised pattern and a substrate 535 are provided, wherein the ink is one element of the group consisting of red ink, green ink and blue ink. Next, the raised pattern on the inkpad 545 is inked uniformly, wherein the inkpad 545 is moved along a first direction 555 and contacted with the stamp apparatus 540 at a first point, while the substrate 535 is moved along a second direction 550 and contacted with the stamp apparatus 540 at a second point, in addition, the first direction 555 is parallel and in opposite direction with the second direction 550. Then, the inkpad 545 and the substrate 535 are moved along the first and second direction 555 and 550, and the stamp apparatus 540 is operated. At the first point, the predetermined region of the stamp apparatus 540 is inked by the inkpad 545, so as to transfer the raised pattern on the stamp apparatus 540. Next, at the second point, the predetermined region of the substrate 535 is inked by the inked stamp apparatus 540, so as to transfer the raised pattern on the surface of the substrate 535. Afterwards, a fixation process is performed to solidify the ink on the surface of the substrate 535, so as to form a substrate 535 with a solidified ink. Above-mentioned processes are repeated until red, green and blue inks are all solidified on the substrate 535.

Referring to FIG. 6, in this embodiment, the stamp apparatus 540 further comprises a belt conveyer 540B having a flat surface and a plurality of gears 540A on the inside of the belt conveyer 540B. At least two gears are contacted with the belt conveyer 540B, and a plurality of gears is operated to work the stamp apparatus 540.

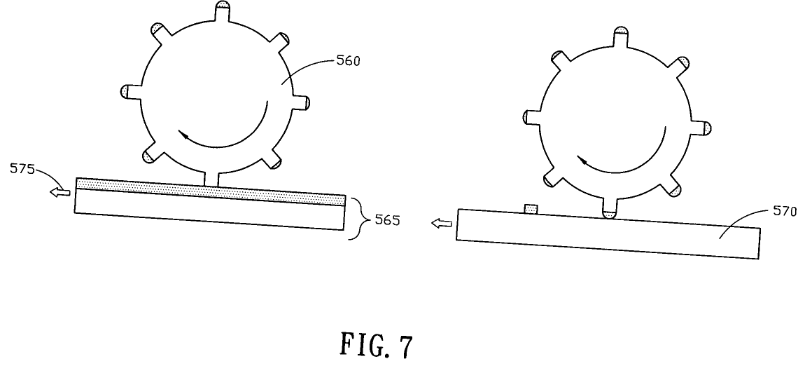

Referring to FIG. 7, which illustrates the seventh preferred embodiment of this invention, a roller stamp 560 having a raised pattern, an inkpad 565 containing an ink and a substrate 570 are provided, wherein the ink is one element of the group consisting of red ink, green ink and blue ink. The inkpad 565 and the substrate 570 are on the same plane and located in specific order, and the plane is moved along a tangent line 575 of the roller stamp 560. Next, the inkpad 565 is moved along the tangent line 575, and the roller stamp 560 is rotated, wherein the whole raised pattern on the roller stamp 560 is inked by the inkpad 565 after the roller stamp 560 rotates a complete circle. Then, the substrate 570 is moved along the tangent line 575 and the roller stamp 560 is kept rotating, and the predetermined region of the substrate 570 is inked by the inked roller stamp 560, so as to transfer the raised pattern on the surface of the substrate 570. Afterwards, a fixation process is performed to solidify the ink on the surface of the substrate 570, so as to form a substrate with a solidified ink. Above-mentioned processes are repeated until red, green and blue inks are all solidified on the substrate 535.

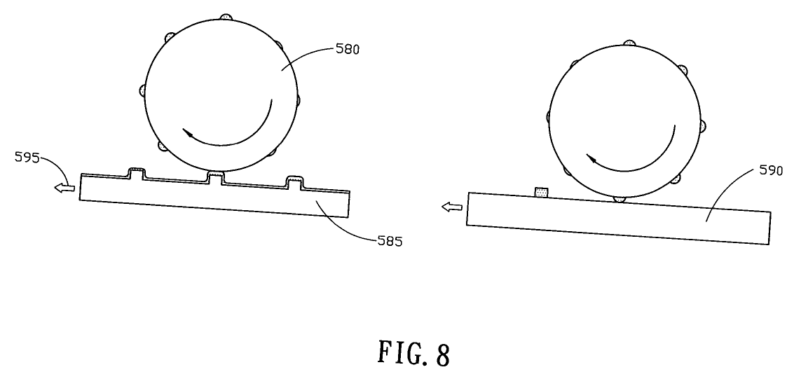

Referring to FIG. 8, which illustrates the eighth preferred embodiment of this invention, a roller stamp 580, an ink, an inkpad 585 having a raised pattern and a substrate 590 are provided, wherein the ink is one element of the group consisting of red ink, green ink and blue ink. The raised pattern on the inkpad 585 is inked, wherein the inkpad 585 and the substrate 590 are on the same plane and located in specific order, and the plane is moved along a tangent line 595 of the roller stamp 580. Next, the inkpad 585 is moved along the tangent line 595, and the roller stamp 580 is rotated, wherein the predetermined region of the roller stamp 585 is inked by the inkpad 585, so as to transfer the whole raised pattern on the roller stamp 580 after the roller stamp 580 rotates a complete circle. Then, the substrate 590 is moved along the tangent line 595 and the roller stamp 580 is kept rotating, and the predetermined region of the substrate 590 is inked by the inked roller stamp 580, so as to transfer the raised pattern on the surface of the substrate 590. Afterwards, a fixation process is performed to solidify the ink on the surface of the substrate 590, so as to form a substrate with a solidified ink. Above-mentioned processes are repeated until red, green and blue inks are all solidified on the substrate 590.

In accordance with the present invention, a micro-stamping method for photoelectric process is provided. By utilizing the stamp or the inkpad having a specific raised pattern and positioning apparatus, the present invention can position and ink the substrate precisely, then the specific patterns are formed on the substrate. Comparing to conventional skills, this invention simplifies the complicated process by leaving out the lithographic process, and then reducing the cost. Therefore, the present invention does have economic advantages and can be applied in industries.

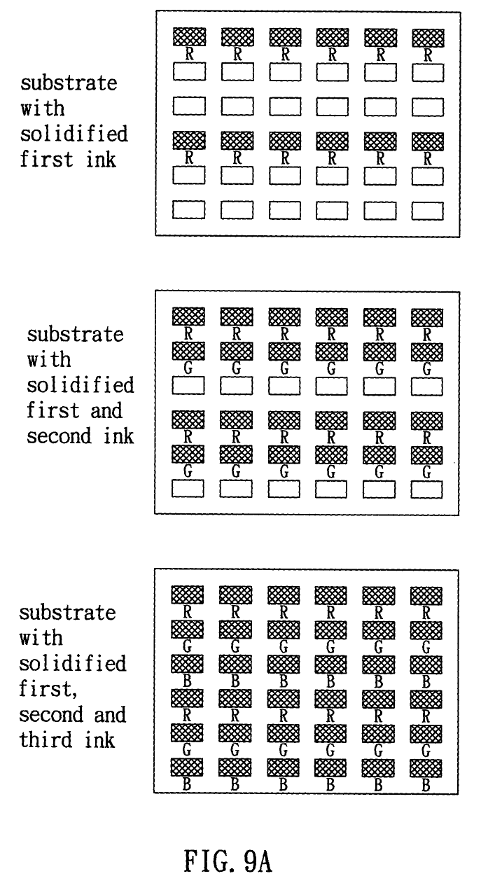

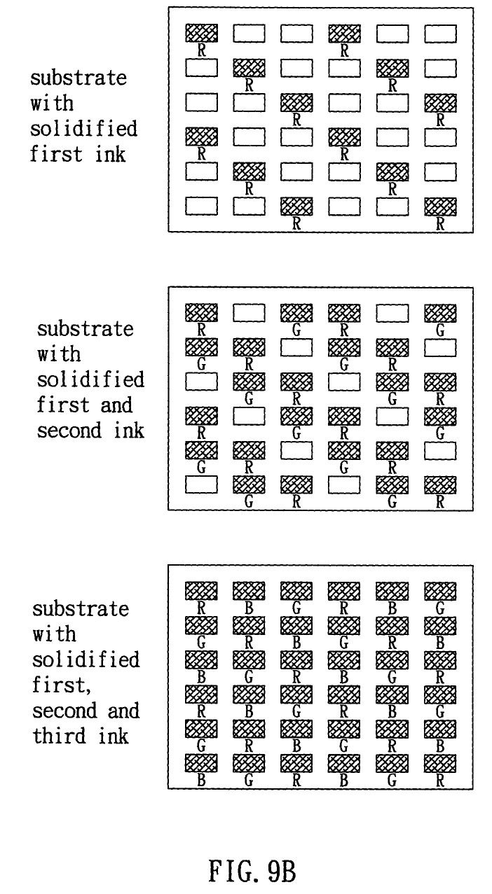

According to above-mentioned embodiments, this invention discloses a micro-stamping method for photoelectric process. First of all, in this invention, the micro-stamping method provides a stamp, an ink, an inkpad and a substrate, wherein the stamp or the inkpad having a specific raised pattern and the ink is one element of the group consisting of red ink, green ink and blue ink. Further, by adherence of the ink to the stamp, the specific pattern can be transferred to the surface of the substrate. Furthermore, this micro-stamping method comprises an ink adherence process, a positioning process, a pattern transferring process and a fixation process, and the above-mentioned processes will repeat until the three inks, such as red ink, green ink and blue ink, all adhered and fixed on the predetermined places of substrate. Referring to FIG. 9A and FIG. 9B, the substrate orderly inked with different inks are shown. Moreover, this invention can be applied in the fabricating of color filters of TFT-LCD, emitting layers of OLED (Organic Light Emitting Diode), emitting layers of PLED Polymer Light Emitting Diode) or other related photoelectric processes.

Although only three specific embodiments have been illustrated and described, it will be obvious to those skilled in this art that various modifications may be made without departing from what is intended to be limited solely by the appended claims. Obviously, many modifications and variations of the present invention are possible in light of the above teachings. It is therefore to be understood that within the scope of the appended claims, the present invention may be practiced otherwise than as specifically described herein.

1. A micro-stamping method for photoelectric process, comprising:
providing a stamp having a raised pattern, an inkpad containing an ink and a substrate;
performing an ink adherence process by said inkpad to ink said raised pattern on said stamp;
performing a positioning process to move said inked stamp to a specific place precisely relative to the predetermined region of said substrate;
performing a pattern transferring process by said inked stamp to ink said predetermined region of said substrate, so as to transfer said raised pattern on the surface of said substrate; and
performing a fixation process to solidify said ink on said surface of said substrate, so as to form a substrate with a solidified ink.

2. The method according to claim 1, wherein said stamp is a plate stamp.

3. The method according to claim 2, wherein said plate stamp further comprises a plurality of spacers, and said plurality of spacers and said raised pattern are located at the same surface of said plate stamp, and furthermore said plurality of spacers are with a first height, while said raised pattern are with a second height.

4. The method according to claim 3, wherein said first height is larger than said second height.

5. The method according to claim 3, wherein said plurality of spacers are height-adjustable.

6. The method according to claim 3, wherein said substrate further comprises a plurality of dents for contacting said plurality of spacers.

7. The method according to claim 3, wherein said plate stamp further comprises a flexible material so that said plate stamp can deform to operate inking process with the support of said spacers.

8. The method according to claim 1, wherein said stamp is a roller stamp.

9. The method according to claim 8, wherein said inkpad is an automatic ink dropping apparatus, and said automatic ink dropping apparatus comprises:
an ink tank; and
an ink dropper, wherein said ink dropper is below said ink tank, so said ink is transported from said ink tank by said ink dropper.

10. The method according to claim 8, wherein said inkpad is an automatic ink feeder, and said automatic ink feeder comprises:
an ink tank; and
a foam roller, wherein said foam roller is rotated and partially contacted with said ink, so as to uniformly spread said ink on the surface of said foam roller by capillarity.

11. The method according to claim 1, wherein said ink is one element of the group consisting of red ink, green ink and blue ink.

12. The method according to claim 1, wherein said stamp is connected with an arm which moves freely above said inkpad and said substrate so that said stamp can contact said inkpad and substrate in turn.

13. The method according to claim 1, wherein said inkpad and substrate are connected to each other by a connect device which is further connected to an arm moving freely so that said inkpad and substrate can contact said stamp in turn.

14. A micro-stamping method for photoelectric process, comprising: to move the inked first stamp 100 to a specific place precisely relative to the first predetermined region of the substrate 104
inking uniformly said raised pattern on said inkpad;
moving said inked inkpad to a specific place precisely relative to the predetermined region of said stamp;
inking predetermined region of said stamp by said inkpad and transfer said raised pattern on the surface of said stamp;
moving said inked stamp to the predetermined region of said substrate;
inking said predetermined region of said substrate by said stamp, so as to transfer said raised pattern on the surface of said substrate; and
performing a fixation process to solidify said ink on said surface of said substrate, so as to form a substrate with a solidified ink.

15. The method according to claim 14, wherein said stamp is a plate stamp.

16. The method according to claim 15, wherein said plate stamp further comprises a plurality of spacers with a first height, and said plurality of spacers are located on a specific surface of said stamp, wherein said specific surface is inked.

17. The method according to claim 16, wherein said inkpad is with a second height, and said first height is larger than said second height.

18. The method according to claim 16, wherein said plurality of spacers are height-adjustable.

19. The method according to claim 16, wherein said substrate further comprises a plurality of dents for contacting said plurality of spacers.

20. The method according to claim 16, wherein said plate stamp further comprises a flexible material so that said plate stamp can deform to operate the inking process with the support of said spacers.

21. The method according to claim 14, wherein said stamp is a roller stamp.

22. The method according to claim 14, wherein said ink is one element of the group consisting of red ink, green ink and blue ink.

23. The method according to claim 14, wherein said stamp is connected with an arm which moves freely above said inkpad and said substrate so that said stamp can contact said inkpad and substrate in turn.

24. The method according to claim 14, wherein said inkpad and substrate are connected to each other by a connect device which is further connected to an arm moving freely so that said inkpad and substrate can contact said stamp in turn.

25. A micro-stamping method for photoelectric process, comprising:
providing a roller stamp having a raised pattern, an inkpad containing an ink and a substrate, wherein said inkpad is moved along a first tangent line of said roller stamp and contacted with said roller stamp at a first point of tangency, while said substrate is moved along a second tangent line of said roller stamp and contacted with said roller stamp at a second point of tangency, and said first tangent line is parallel and in opposite direction with said second tangent line;
moving said inkpad and said substrate along said first and second tangent lines, and rotating said roller stamp;
Inking said raised pattern on said roller stamp by said inkpad at said first point of tangency;
Inking the predetermined region of said substrate by the inked roller stamp at said second point of tangency, so as to transfer said raised pattern on the surface of said substrate; and
performing a fixation process to solidify said ink on said surface of said substrate, so as to form a substrate with a solidified ink.

26. A micro-stamping method for photoelectric process, comprising:
providing a roller stamp, an ink, an inkpad having a raised pattern and a substrate, and inking said raised pattern on said inkpad, wherein said inkpad is moved along a first tangent line of said roller stamp and contacted with said roller stamp at a first point of tangency, while said substrate is moved along a second tangent line of said roller stamp and contacted with said roller stamp at a second point of tangency, and said first tangent line is parallel and in opposite direction with said second tangent line;
moving said inkpad and said substrate along said first and second tangent lines, and rotating said roller stamp;
Inking the predetermined region of said roller stamp by said inkpad at said first point of tangency, so as to transfer said raised pattern on the surface of said roller stamp;
Inking the predetermined region of said substrate by the inked roller stamp at said second point of tangency, so as to transfer said raised pattern on the surface of said substrate; and
performing a fixation process to solidify said ink on said surface of said substrate, so as to form a substrate with a solidified ink.

27. A micro-stamping method for photoelectric process, comprising:
providing a stamp apparatus having a raised pattern, an inkpad containing an ink and a substrate, wherein said inkpad is moved along a first direction and contacted with said stamp apparatus at a first point, while said substrate is moved along a second direction and contacted with said stamp apparatus at a second point, and said first direction is parallel and in opposite direction with said second direction;
moving said inkpad and said substrate along said first and second direction, and operating said stamp apparatus;
Inking said raised pattern on said stamp apparatus by said inkpad at said first point;
Inking the predetermined region of said substrate by the inked stamp apparatus at said second point, so as to transfer said raised pattern on the surface of said substrate; and
performing a fixation process to solidify said ink on said surface of said substrate, so as to form a substrate with a solidified ink.

28. The method according to claim 27, wherein said stamp apparatus comprising:
a belt conveyer, wherein said belt conveyer having predetermined raised pattern outside thereon; and
a plurality of gears, wherein said plurality of gears are on the inside of said belt conveyer, and at least two gears contacted with said belt conveyer, and said plurality of gears are operated, so as to work said stamp apparatus.

29. A micro-stamping method for photoelectric process, comprising:
providing a stamp apparatus, an ink, an inkpad having a raised pattern and a substrate, and inking said raised pattern on said inkpad, wherein said inkpad is moved along a first direction and contacted with said stamp apparatus at a first point, while said substrate is moved along a second direction and contacted with said stamp apparatus at a second point, and said first direction is parallel and in opposite direction with said second direction;
moving said inkpad and said substrate along said first and second direction, and operating said stamp apparatus;
Inking the predetermined region of said stamp apparatus by said inkpad at said first point, so as to transfer said raised pattern on said stamp apparatus;
Inking the predetermined region of said substrate by the inked stamp apparatus at said second point, so as to transfer said raised pattern on the surface of said substrate; and
performing a fixation process to solidify said ink on said surface of said substrate, so as to form a substrate with a solidified ink.

30. The method according to claim 29, wherein said stamp apparatus comprising:
a belt conveyer, wherein said belt conveyer having a flat surface; and
a plurality of gears, wherein said plurality of gears are on the inside of said belt conveyer, and at least two gears contacted with said belt conveyer, and said plurality of gears are operated, so as to work said stamp apparatus.

31. A micro-stamping method for photoelectric process, comprising:
providing a roller stamp having a raised pattern, an inkpad containing an ink and a substrate, wherein said inkpad and said substrate are on the same plane and located in specific order, and said plane is moved along a tangent line of said roller stamp;
moving said inkpad along said tangent line, and rotating said roller stamp, wherein said raised pattern on said roller stamp is inked by said inkpad after said roller stamp rotates a complete circle;
moving said substrate along said tangent line and keeping said roller stamp rotating, then the predetermined region of said substrate is inked by the inked roller stamp, so as to transfer said raised pattern on the surface of said substrate; and
performing a fixation process to solidify said ink on said surface of said substrate, so as to form a substrate with a solidified ink.

32. A micro-stamping method for photoelectric process, comprising:
providing a roller stamp, an ink, an inkpad having a raised pattern and a substrate, and inking said raised pattern on said inkpad, wherein said inkpad and said substrate are on the same plane and located in specific order, and said plane is moved along a tangent line of said roller stamp;
moving said inkpad along said tangent line, and rotating said roller stamp, wherein said predetermined region of said roller stamp is inked by said inkpad, so as to transfer said raised pattern on said roller stamp after said roller stamp rotates a complete circle;
moving said substrate along said tangent line and keeping said roller stamp rotating, then the predetermined region of said substrate is inked by the inked roller stamp, so as to transfer said raised pattern on the surface of said substrate; and
performing a fixation process to solidify said ink on said surface of said substrate, so as to form a substrate with a solidified ink.
